(19) United States
(12) Patent Application Publication
(10) Pub. No.: US 2007/0222241 A1
(43) Pub. Date: Sep. 27, 2007

(54) Multi-function hand tool

(76) Inventor: Dara Cheng, Nashville, TX (US)

Correspondence Address: ERIC HANSCOM, 7395 PORTAGE WAY, CARLSBAD, CA, 92011, US

(21) Appl. No.: 11/386,857

(22) Filed: Mar. 23, 2006

(51) Int. Cl. B25J 1/02

(52) U.S. Cl. 294/19.1

(57) ABSTRACT

The present invention involves a multi-function hand-held tool having a handle portion, an extension portion, and an attachment portion. The handle portion includes a spring-loaded trigger. The extension portion includes an elongated flexible shaft enclosing a control rod that is attached to a triangular block. The attachment portion includes a fixed attachment member and a rotatable attachment member, each preferably having two protrusions located on one end for securely receiving various removable attachments, such as spark plug boot removal members, cutting members, and plier members. The elongated flexible shaft allows the positioning of the handle portion away from the attachment portion and potential harmful objects to help minimize injury to the user when exerting a force on the handle portion.

### CROSS REFERENCE TO RELATED APPLICATIONS

None.

### STATEMENT REGARDING FEDERALLY SPONSORED RESEARCH OR DEVELOPMENT

This invention was not federally sponsored.

### BACKGROUND OF INVENTION

1. Field of the Invention

The invention generally relates to the field of hand-held mechanical devices. More particularly, the present invention relates to hand-held tools capable of receiving various removable attachments.

2. Description of the Related Art

Mechanics typically must use various tools when working on engines and other automobile components. Purchasing several tools can not only be expensive, but also requires more space to store the tools. Further, when different tools are required to complete a job, a mechanic must frequently search through a toolbox to find the appropriate tool—a task that can sometimes be frustrating as well as time consuming.

Also, some tasks require special tools. For example, removing the boot from around a spark plug must be performed carefully, as the spark plug and the threads with which it is inserted into the engine block are a delicate and essential part of the engine. Pulling on the spark plug wire itself may break an internal electrical connection, preventing the timing signal from ever reaching the spark plug in the future. At the same time, spark plugs are located fairly deep within the hood of a car, making them difficult to reach. In addition, sparks plugs in many vehicles are slanted at various angles, so even if a mechanic grasps the boot with his or her hand, there is a danger that in removing the boot the mechanic's hand will be injured as the hand smashes into the car body after the boot releases its hold on the spark plug. Thus, a mechanic must generally purchase a special tool to separate a spark plug boot from a spark plug.

It can be expensive to purchase several special tools that have only one primary use. Therefore, there is a present need for a hand-held device that can be used for various mechanically-related tasks, including removing spark plug boots from spark plugs, that is efficient, cost-effective, easy to use, and helps minimize the risk of injury to the user.

In this respect, before explaining at least one embodiment of the invention in detail it is to be understood that the invention is not limited in its application to the details of construction and to the arrangement of the components set forth in the following description or illustrated in the drawings. The invention is capable of other embodiments and of being practiced and carried out in various ways. In addition, it is to be understood that the phraseology and terminology employed herein are for the purpose of description and should not be regarded as limiting.

### SUMMARY OF THE INVENTION

A primary object of this invention is to provide a hand held tool that can be used to perform several mechanically-related tasks, such as removing the boot from a spark plug attached to an engine.

It is a further object of this invention to provide a quick and efficient tool for accomplishing the removal of the spark plug boot with minimum damage to the boot, spark plug, spark plug wire, and the hand of the user.

It is another object of this invention that a user be able to maneuver the flexible shaft of the invention to avoid engine obstacles.

It is a further object of this invention to provide a hand tool with attachments that can be easily removed and reconnected to allow a user to perform several tasks.

It is a still another object of this invention to provide a unique hand-held multi-functional device to the field of hand-held mechanical devices.

These objects and further objects and features of the invention will be apparent to one skilled in the art from the disclosure of the present invention as set forth herein.

The present invention involves a multi-function hand-held tool having a handle portion, an extension portion, and an attachment portion. The handle portion includes a spring-loaded trigger. The extension portion includes an elongated flexible shaft enclosing a control rod that is attached to a triangular block. The attachment portion includes a fixed attachment member and a rotatable attachment member, each preferably having two protrusions located on one end for securely receiving various removable attachments, such as spark plug boot removal members, cutting members, and plier members. The elongated flexible shaft allows the positioning of the handle portion away from the attachment portion and potential harmful objects to help minimize injury to the user when exerting a force on the handle portion.

There has thus been outlined, rather broadly, the more important features of the invention in order that the detailed description thereof may be better understood, and in order that the present contribution to the art may be better appreciated. There are additional features of the invention that will be described hereinafter and which will form the subject matter of the claims appended hereto.

### BRIEF DESCRIPTION OF THE DRAWINGS

The accompanying drawings, which are incorporated in and form a part of this specification, illustrate embodiments of the invention and together with the description, serve to explain the principals of this invention.

FIG. 1 is perspective view of the preferred embodiment of the hand tool with removable attachments detached.

FIG. 2 is cross-sectional view of the preferred embodiment of the hand tool with removable attachments detached.

FIG. 3A shows a side view of the plier attachment members unattached from the attachment member body.

FIG. 3B shows a side view of the cutting attachment members unattached from the attachment member body.

FIG. 3C shows a top view of the spark plug boot removal attachment members unattached from the attachment member body.

FIG. 3D shows a partial end view of the spark plug boot removal attachment members unattached from attachment member body.

FIG. 3E shows a bottom perspective view of one of the spark plug boot removal attachment members, illustrating the angular bend of approximately 20 degrees contained in both members.

FIG. 4 shows a side view of the attachment of one of the spark plug boot removal attachment members to an attachment body attachment member.

FIG. 5 shows a bottom view of the attachment of both of the spark plug boot removal attachment members to the attachment body attachment members.

FIG. 6 shows a perspective view of the positioning of the attachment portion of the hand tool with the spark plug boot removal attachment members attached, just prior to engagement with a spark plug boot.

### DETAILED DESCRIPTION OF THE INVENTION

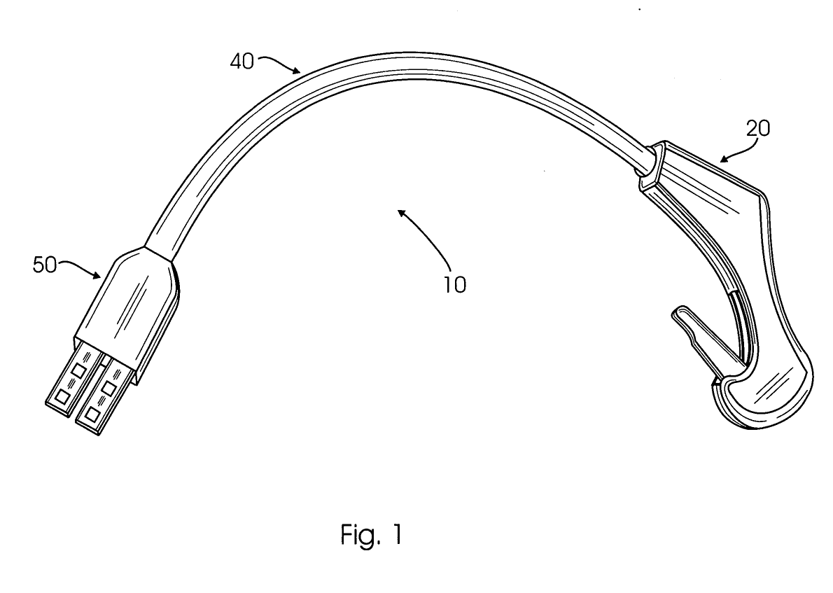

Referring now to the drawings, FIG. 1 shows a perspective view of the preferred embodiment of hand tool with removable attachments 10. Hand tool 10 preferably includes a handle portion 20, an extension portion 40, and an attachment portion 50. Handle portion 20 and attachment portion 40 are preferably comprised of a strong and durable plastic material, but can also be comprised of metal or other suitable material as would be recognized by one with ordinary skill in the art.

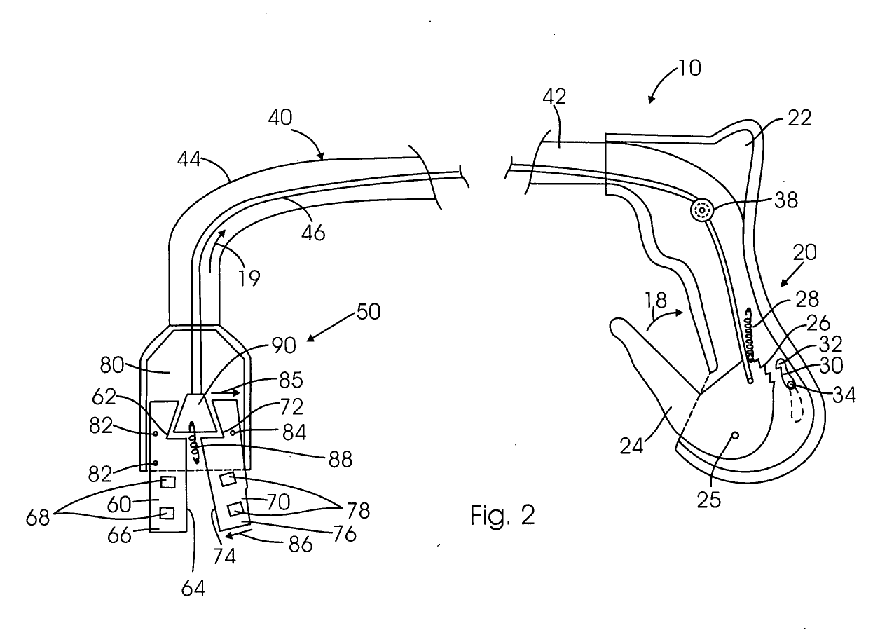

FIG. 2 shows a cross-sectional view of hand tool 10. Handle portion 20 includes two opposing mating halves 22 (one shown). A trigger 24 having teeth 26 is positioned between mating halves 22. A return spring 28 is attached on one end to the interior of handle portion 20 and on the other end to trigger 24. Return spring 28 ensures that when a user is not compressing trigger 24, trigger 24 is in an “open” position. If a user is compressing trigger 24, the user can “lock” trigger 24 in a “closed” position by depressing a lock tab 30, causing a lock tooth 32 to rotate about a lock pivot point 34 and catch in teeth 26.

Attachment portion 50 includes a fixed attachment member 60 and a rotatable attachment member 70. Fixed attachment member 60 is attached to an attachment member body 80 at attachment points 82, while rotatable attachment member 70 is attached to attachment member body 80 at attachment point 84. Attachment point 84 serves as a pivot point for rotatable attachment member 70. Fixed attachment member 60 contains an indentation 62 located on one side 64 of the portion contained within attachment member body 80. Similarly, rotatable attachment member 70 also contains an indentation 72 located on one side 74 of the portion contained within attachment member body 80. Indentation 62 and indentation 72 are angular depressions that, when both contacted by a triangular pull block 90, cause the portion of rotatable attachment member 70 contained within attachment member body 80 to move outwardly from fixed attachment member 60 (shown by arrow 85), to cause rotatable attachment member end 76 to move inwardly toward fixed attachment member 60 (shown by arrow 86). When pull block 90 is not being pulled back by a user compressing trigger 24, a return spring 88 returns pull block 90 to its normal position, in which rotatable attachment member 70 is in the “open” position.

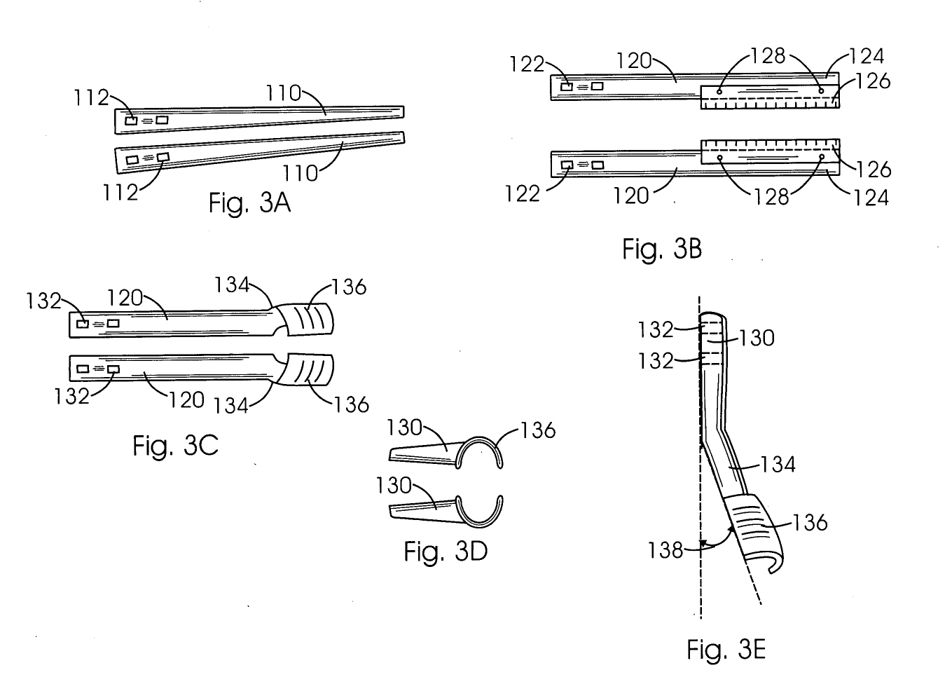

Fixed attachment member 60 contains an end 66 that preferably has two attachment points 68, but can contain more to permit a more secure attachment of a removable attachment member (see FIGS. 3A, 3B, 3C). Similarly, rotatable attachment member 70 contains an end 76 that preferably has two attachment points 78, but can contain more to permit a more secure attachment of a removable attachment member. Attachment points 68 and 78 are preferably small protrusions that receive and allow the removable attachment members to securely connect to fixed attachment member 60 and rotatable attachment member 70 respectively. However, the present invention also contemplates attachment points 68 and 78 that can be openings contained within fixed attachment member 60 and rotatable attachment member 70, wherein protrusions located on removable attachment members (not shown) can be positioned therein, or other attachment means such as indentations for snapping or locking members.

Extension portion 40 is comprised of a flexible shaft 42. Shaft 42 contains an outer body 44. Shaft 42 allows a mechanic to maneuver hand tool 10 around obstacles in a vehicle engine or other crowded area and still be able to effectively perform tasks, such as removing the boot from a spark plug. Outer body 44 encloses a control rod 46. Control rod 46 is preferably a piece of metal that begins in pull block 90 and can be secured within pull block 90 by untwisting its wires (not shown) and allowing the wires to cool in pull block 90 as pull block 90 is cooling after having been poured into a mold. Alternatively, if pull block 90 is comprised of two pieces that are hammered or pressed together, the wires can be positioned between the pieces before the hammering or pressing for secure attachment. Control rod 46 extends from pull block 90 into handle portion 20, passing over a control rod guide 36, terminating at trigger 24. Control rod guide 36 rotates freely within handle portion 20, ensuring that control rod 46 can move freely. Thus, when a user pulls back on trigger 24, trigger 24 rotates about trigger pivot 25 in a clockwise direction (shown by arrow 18) and exerts a pull on control rod 46 in a direction shown by arrow 19, causing rotatable attachment member 70 to move inward toward fixed attachment member 60.

FIG. 3A shows a side view of plier attachment members 110 unattached from attachment member body 80. Plier attachment members 110 each have preferably two openings 112 to engage with protrusions 68 and 78 to secure plier attachment members 110 to hand tool 10. However, plier attachment members 110 can each have more than two openings 112 to allow for a more secure attachment to fixed attachment member 60 and rotatable attachment member 70. Plier attachment members 110 can also contain other attachment means, such as protrusions for snapping or inter-locking attachment, or other means as would be recognized by one with ordinary skill in the art.

FIG. 3B shows a side view of cutting attachment members 120 unattached from attachment member body 80. Cutting attachment members 120 each have preferably two openings 122 to engage with protrusions 68 and 78 to secure cutting attachment members 120 to hand tool 10. However, cutting attachment members 120 can each have more than two openings 122 to allow for a more secure attachment to fixed attachment member 60 and rotatable attachment member 70. Cutting attachment members 120 can also contain other attachment means, such as protrusions for snapping or inter-locking attachment, or other means as would be recognized by one with ordinary skill in the art. Each end 124 of both cutting attachment members 120 opposite openings 122 contain a cutting portion 126 attached by attachment points 128.

FIG. 3C shows a top view of the spark plug boot removal attachment members 130 unattached from attachment member body 80. Attachment members 130 each have preferably two openings 132 on one end to engage with protrusions 68 and 78 to secure attachment members 130 to hand tool 10. However, attachment members 130 can each have more than two openings 132 to allow for a more secure attachment to fixed attachment member 60 and rotatable attachment member 70. Attachment members 130 can also contain other attachment means, such as protrusions for snapping or inter-locking attachment, or other means as would be recognized by one with ordinary skill in the art. The ends 136 of attachment members 130 opposite openings 132 each contain a bend 134. Each bend 134 offsets ends 136 of attachment members 130 by approximately 20 degrees from the end of attachment members 130 containing openings 132. Ends 136 are curved surfaces intended to, when pushed toward each other, form a circle of a diameter slightly smaller than the boot which covers a spark plug (not shown).

FIG. 3D shows a partial end view of the spark plug boot removal attachment members 130 unattached from attachment member body 80.

FIG. 3E shows a bottom perspective view of one of the spark plug boot removal attachment members 130, illustrating the angular bend 138 of approximately 20 degrees contained in both attachment members 130.

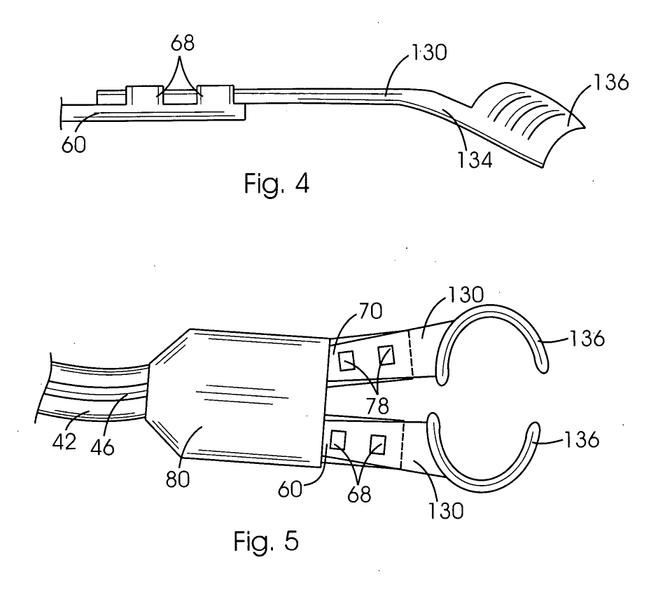

FIG. 4 shows a side view of the attachment of one of the spark plug boot removal attachment members 130 to a fixed attachment member 60. Protrusions 68 align with openings 132 (not shown) to securely attach attachment member 130 to fixed attachment member 60. Rotatable attachment member 70 (not shown) is attached to attachment member 130 in a similar fashion.

FIG. 5 shows a bottom view of the attachment of both of the spark plug boot removal attachment members 130 to fixed attachment member 60 and rotatable attachment member 70. Shown are the relative positions of flexible shaft 42, attachment member body 80, fixed attachment member 60, rotatable attachment member 70, and spark plug boot removal attachment members 130.

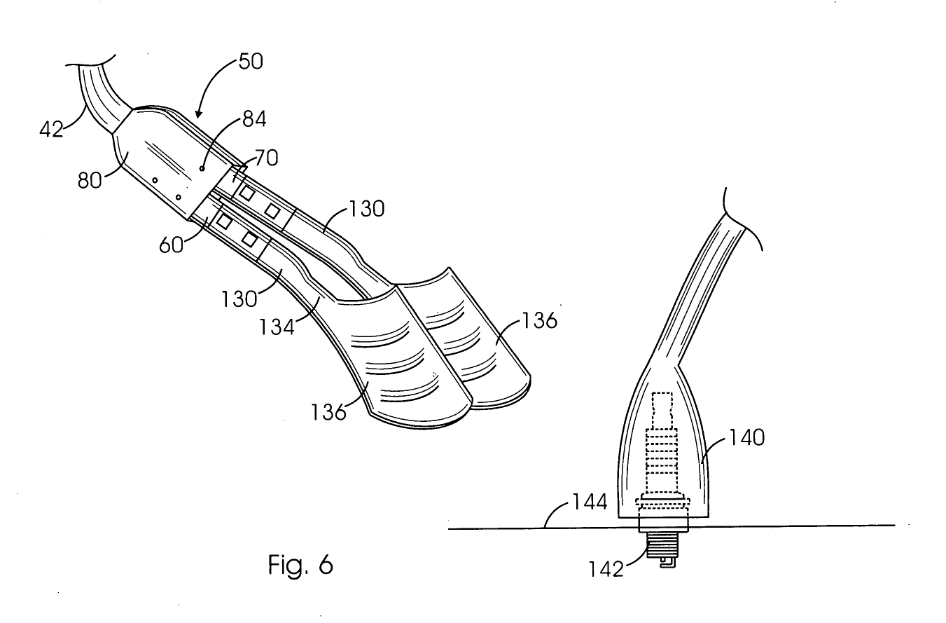

FIG. 6 shows a perspective view of the positioning of attachment portion 50 with spark plug boot removal attachment members 130 attached, just prior to engagement with a spark plug boot 140. Spark plug boot 140 covers spark plug 142, which is attached to engine 144. As ends 136 are lowered around spark plug boot 140, a user compresses trigger 24, which pulls control rod 36 and thus pull block 80 (see FIG. 2), causing rotatable attachment member 70 to rotate about attachment point 84 such that ends 136 close around spark plug boot 140. When closed, because ends form a circle that has a diameter that is smaller than the diameter of spark plug boot 140, ends 136 will provide a secure engagement of hand tool 10 to spark plug boot 140. While still compressing trigger 24 or after trigger 24 has been “locked” by depressing lock tab 30 (not shown), a user can then exert a force on handle portion 20 (not shown) away from engine 144 to separate spark plug boot 140 from spark plug 142.

Because of the angular positioning of fixed attachment member 60 and rotatable attachment member 70, a user can pull the invention upward in a purely vertical manner and still remove the boot. This allows the user to exert the force from an area outside of the engine compartment, where there is no risk of injuring a user's hand against the engine or car. Previous spark plug boot removal devices require a user to pull in the opposite direction to which the spark plug is attached to the engine, which often requires still pulling within the engine and hood region, thereby increasing the chance that when the boot disengages from the spark plug the user's hand will smash into other engine components or the car body itself.

With respect to the above description it is to be realized that the optimum dimensional relationships for the parts of the invention, including variations in size, materials, shape, form, function and manner of operation, assembly, and use, are deemed readily apparent and obvious to one skilled in the art, and all equivalent relationships to those illustrated in the drawings and described in the specification are intended to be encompassed by the present invention. Therefore, the foregoing is considered as illustrative only of the principles of the invention. Further, since numerous modifications and changes will readily occur to those skilled in the art, it is not desired to limit the invention to the exact construction and operation shown and described. Accordingly, all suitable modifications and equivalents fall within the scope of the present invention.

The above description, together with the objects of the invention and the various features of novelty which characterize the invention, are pointed out with particularity in the claims annexed to and forming a part of this disclosure. For a better understanding of the invention, its operating advantages and the specific advantages attained by its uses, reference should be made to the accompanying drawings and descriptive matter in which there are illustrated preferred embodiments of the invention.

Further, the purpose of the foregoing abstract is to enable the U.S. Patent and Trademark Office and the public generally, and especially the scientists, engineers, and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting, as to the scope of the invention in any way.

I claim:

1. A multi-functional hand tool, comprising:
a) a handle portion, the handle portion comprising two opposing mating halves substantially bounding an interior region, a trigger rotatably attached to the handle portion, one end of the trigger being disposed within the interior region and the other end of the trigger extending from the interior region;
b) an extension shaft coupled on one end to the handle portion;
c) an attachment portion coupled to the other end of the extension shaft, the attachment portion comprising an attachment body, a fixed attachment member coupled to the attachment body, a rotatable attachment member coupled to the attachment body, the fixed attachment member and the rotatable attachment member both having means for receiving an attachment, and a pull block disposed within the region bounded by the attachment body and between indentations formed within both the fixed attachment member and the rotatable attachment member; and
d) a control rod coupled on one end to the end of the trigger disposed within the interior region and on the other end to the pull block, the control rod extending from the handle portion through the extension shaft to the attachment portion
wherein a user can removably attach various attachments to both the fixed attachment member and the rotatable attachment member, then position the attachment portion over an object to be acted upon, and compress the end of the trigger extending from the interior region, causing the control rod to exert a force on and lift the pull block into contact with the fixed attachment member and the rotatable attachment member, causing the rotatable attachment member to move towards the fixed attachment member and thus perform the function of the attachment on the object.

2. The multi-functional hand tool of claim 1, wherein the means for receiving an attachment is at least two protrusions positioned on one side of each of the fixed attachment member and the rotatable attachment member.

3. The multi-functional hand tool of claim 1 further comprising a return spring coupled on one end to the end of the trigger disposed within the interior region and on the other end to one of the mating halves for the purpose of returning the trigger to an uncompressed position when the trigger is not being compressed by a user.

4. The multi-functional hand tool of claim 1, wherein the extension shaft is flexible.

5. The multi-functional hand tool of claim 1, wherein the pull block is triangular in shape.

6. The multi-functional hand tool of claim 1, wherein the handle portion further comprises a lock tab disposed within the interior region for the purpose of locking the trigger into a compressed position.

7. The multi-functional hand tool of claim 6, wherein the trigger further comprises a plurality of teeth for the purpose of engaging the lock tab.

8. The multi-functional hand tool of claim 1 further comprising a control rod guide rotatably disposed within the interior region for the purpose of guiding the control rod within the handle portion.

9. The multi-functional hand tool of claim 1 further comprising an attachment member removably attached to both the fixed attachment member and the rotatable attachment member.

10. The multi-functional hand tool of claim 9, wherein the attachment member is a needle-nose plier member.

11. The multi-functional hand tool of claim 9, wherein the attachment member is a cutting tool member.

12. The multi-functional hand tool of claim 9, wherein the attachment member is a spark plug boot removal member.

13. The multi-functional hand tool of claim 12, wherein the distal end of the spark plug boot removal member contains a semi-circular region for clamping to a spark plug boot.

14. The multi-functional hand tool of claim 1 further comprising a pull block return spring coupled on one end to one end of the pull block and on the other end to the grasping body for the purpose of returning the pull block to a resting position when the trigger is uncompressed.

15. A multi-functional hand tool comprising:
a) a handle portion, the handle portion comprising two opposing mating halves substantially bounding an interior region, a trigger rotatably attached to the handle portion, one end of the trigger being disposed within the interior region and the other end of the trigger extending from the interior region, the end of the trigger disposed within the interior region having a plurality of teeth, a lock tab disposed within the interior region for the purpose of engaging one or more of the plurality of teeth to lock the trigger into a compressed position
b) a flexible extension shaft coupled on one end to the handle portion;
c) an attachment portion coupled to the other end of the extension shaft, the attachment portion comprising an attachment body, a fixed attachment member coupled to the attachment body, a rotatable attachment member coupled to the attachment body, the fixed attachment member and the rotatable attachment member both having means for receiving an attachment, and a pull block disposed within the region bounded by the attachment body and between indentations formed within both the fixed attachment member and the rotatable attachment member;
d) a control rod coupled on one end to the end of the trigger disposed within the interior region and on the other end to the pull block, the control rod extending from the handle portion through the extension shaft to the grasping portion; and
e) a pull block return spring coupled on one end to one end of the pull block and on the other end to the grasping body for the purpose of returning the pull block to a resting position when the trigger is uncompressed
wherein a user can removably attach various attachments to both the fixed attachment member and the rotatable attachment member, then position the attachment portion over an object to be acted upon, and compress the end of the trigger extending from the interior region, causing the control rod to exert a force on and lift the pull block into contact with the fixed attachment member and the rotatable attachment member, causing the rotatable attachment member to move towards the fixed attachment member and thus perform the function of the attachment on the object.

16. The multi-functional hand tool of claim 15 further comprising an attachment member removably attached to both the fixed attachment member and the rotatable attachment member.

17. An attachment member for removable attachment to a multi-function hand tool comprising:
a) an elongated member, the elongated member containing at least two openings located on one end for the purpose of attachment of the elongated member to a multi-function tool; and
b) means for acting upon an object located on the other end of the elongated member.

18. The attachment member for removable attachment to a multi-function hand tool of claim 17, wherein the means for acting upon an object is a cutting blade.

19. The attachment member for removable attachment to a multi-function hand tool of claim 17, wherein the means for acting upon an object is a semi-circular portion for clamping to a spark plug boot.

20. The attachment member for removable attachment to a multi-function hand tool of claim 19, wherein the elongated member includes a bend at an angle of about twenty degrees.
